(19) United States
(12) Patent Application Publication
(10) Pub. No.: US 2013/0180840 A1
(43) Pub. Date: Jul. 18, 2013

(54) Rotary Selector and Circuit

(71) Applicants: Frank Boesner, Königsbach-Stein (DE); Klaus Trumpa, Balingen (DE); Rolf Streifler, Weilen u.d.R. (DE); Konstantin Freis, Bretten (DE); Wolfgang Hamm, Bretten (DE)

(72) Inventors: Frank Boesner, Königsbach-Stein (DE); Klaus Trumpa, Balingen (DE); Rolf Streifler, Weilen u.d.R. (DE); Konstantin Freis, Bretten (DE); Wolfgang Hamm, Bretten (DE)

(73) Assignee: E.G.O. Elektro-Gerätebau GmbH, Oberderdingen (DE)

(21) Appl. No.: 13/808,554

(22) PCT Filed: Jul. 1, 2011
(86) PCT No.: PCT/EP2011/061145

§ 371 Date: Mar. 28, 2013

(30) Foreign Application Priority Data
Jul. 2, 2010 (DE) 10 2010 030 897.8

(51) Int. Cl. H01H 19/56

(52) U.S. Cl. CPC H01H 19/56
USPC 200/564

(57) ABSTRACT

A rotary selector may include a first switch contact, which is open in an off-mode angular range, and which is closed outside of said off-mode angular range, in particular used for switching on or off an electrical load. An encoding device may generate an angle-dependent code over a predefined angular range. The rotary selector may also include a second switch contact, which is closed in a plurality of start-angular ranges, and which is open outside of said start-angular ranges.

### PRIORITY CLAIM

This application is the National Stage of, and claims priority to, PCT patent application PCT/EP2011/061145 filed Jul. 1, 2011, which claims the priority of German patent application DE 10 2010 030 897.8 filed Jul. 2, 2010.

### TECHNICAL FIELD

The disclosure relates to a rotary selector as well as a circuit having a rotary selector.

### BACKGROUND

Rotary selectors are used for home appliances such as laundry driers and washing machines wherein the rotary selector may be used on the one hand for turning on or off the home appliance and on the other hand for program selection, heating power selection etc. For program selection, said rotary selectors usually include an encoding device generating an angle-dependent code over a predefined angular range with the code corresponding to a program to be selected.

When a program to be executed of the home appliance has been completed, the home appliance is usually automatically, that is to say without user intervention, transferred into an off-mode. In this context, it is desirable that the home appliance does not consume any power in the off-mode. At the same time it is required that the home appliance can be transferred from the off-mode into a standard operating mode again by simple means.

### SUMMARY

It should be appreciated that this Summary is provided to introduce a selection of concepts in a simplified form that are further described below in the Detailed Description. This Summary is not intended to be used to limit the scope of the claimed subject matter.

The disclosure herein provides a rotary selector and a circuit including a rotary selector by means of which a power consumption can be avoided in the off-mode and which allow an easy transfer from the off-mode into a standard operating mode. According to one aspect, a rotary selector includes first and second switch contacts and an encoding device. The first switch contact may be open in an off-mode angular range and closed outside of the off-mode angular range. The encoding device may generate an angle-dependent code over a predefined angular range. The second switch contact may be closed in a number of start-angular ranges and open outside of the start-angular ranges.

According to another aspect, a circuit may include a rotary selector and an electrical load. The rotary selector may include first and second switch contacts and an encoding device similar to the first aspect described above. The electrical load may include first and second supply voltage terminals and at least one switch controlled by the electrical load. A first terminal of the first switch contact may be connected to a first pole of a supply voltage. The switch may be connected between a second terminal of the first switch contact and the first supply voltage terminal The second switch contact may be connected between the first pole of the supply voltage and the first supply voltage terminal

These and further features emerge not only from the claims but also from the description and from the drawings, wherein the individual features can be realized, and can constitute embodiments which are advantageous and which are protectable per se and for which protection is claimed here, in each case on their own or as a plurality in the form of subcombinations in an embodiment of the disclosure and in other fields. The subdivision of the application into individual sections and subheadings does not restrict the statements made under them in terms of their general validity.

### BRIEF DESCRIPTION OF THE DRAWINGS

Advantageous embodiments of the present disclosure are schematically shown in the drawings and are described subsequently. In the drawings:

FIG. 1 shows an electrical equivalent circuit diagram of a first embodiment of a rotary selector according to various embodiments,

FIG. 2 shows a switch state diagram of the switch contacts of the rotary selector shown in FIG. 1,

FIG. 3 shows a circuit diagram of a circuit according to various embodiments including the rotary selector shown in FIG. 1, and

FIG. 4 shows a circuit diagram of a circuit according to various embodiments including a further embodiment of a rotary selector.

### DETAILED DESCRIPTION

According to various embodiments, the rotary selector may include a first switch contact which is open in the off-mode angular range of the rotary selector and which is closed outside of the off-mode angular range, particularly being used for switching on or off electrical loads, and an encoding device generating an angle-dependent code over a predefined angular range of the rotary selector, for example having a value range of eight different codes for selecting eight different programs. The rotary selector may include a second switch contact independent of the first switch contact which is closed in a plurality of start-angular ranges and which is open outside of the start-angular ranges. By means of the second switch contact, it is possible, for example, to reset an electrical load controlled by the rotary selector from an off-mode into a standard mode when the rotary selector is in a position that corresponds to said start-angular ranges or if the rotary selector moves over the latter, respectively. Said switch contacts may, for example, include in each case a related switch spring being actuated or traveled by means of suitable switching cams on a controller/switching cylinder by means of which, in case of a rotation, opening or closing of the corresponding switch contact can be effected.

In a further embodiment, the rotary selector may include a third switch contact which is open in the off-mode angular range and which is closed outside of the off-mode angular range, and/or a fourth switch contact which is closed in the plurality of the start-angular ranges and which is open outside of the start-angular ranges. In this way, for example, a two-phase potential separation can be provided by means of the rotary selector.

In a further embodiment, the off-mode angular range includes angles between −40° and 40°, particularly between −20° and 20°, whereby the symbol “°” refers to angular degrees. In a further embodiment, the number of start-angular ranges corresponds to a number of different codes, which can be encoded by means of the encoding device. The number of start-angular ranges or different codes respectively, can be eight, for example. In this way, re-starting can already be effected by turning the rotary selector from one angle position corresponding to a predefined code or program to a neighboring angle position corresponding to another code or program.

In a further embodiment, the start-angular ranges may be successively arranged over a predefined angular range, for example 360°, in an equidistant manner, i.e. having an identical angular distance with respect to one another. However, as an alternative, said distribution can also be in a different manner. In a further embodiment, each of the start-angular ranges may have a width of ca. 10°.

The circuit of the disclosure herein may include a rotary selector according to the various embodiments, an electrical load having a first and a second supply voltage terminal, as well as at least one switch controlled by the electrical load. A first terminal of the first switch contact is connected to a first pole of a supply voltage, for example the mains voltage, the controllable switch is connected between a second terminal of the first switch contact and the first supply voltage terminal, and the second switch contact is connected between the first pole of the supply voltage and the first supply voltage terminal The first and the second switch contact can be connected in series and connected between the first pole of the supply voltage and the first supply voltage terminal

In a further embodiment, the circuit comprises exactly two switches that are controlled by the electrical load, whereby the first switch is connected between the second terminal of the first switch contact and the first supply voltage terminal, a first terminal of the third switch contact is connected to a second pole of the supply voltage, the second switch is connected between the second terminal of the third switch contact and the second supply voltage terminal, the second switch contact is connected between the first pole of the supply voltage and the first supply voltage terminal, and the fourth switch contact is connected between the second pole of the supply voltage and the second supply voltage terminal In a further embodiment, the switches are relays.

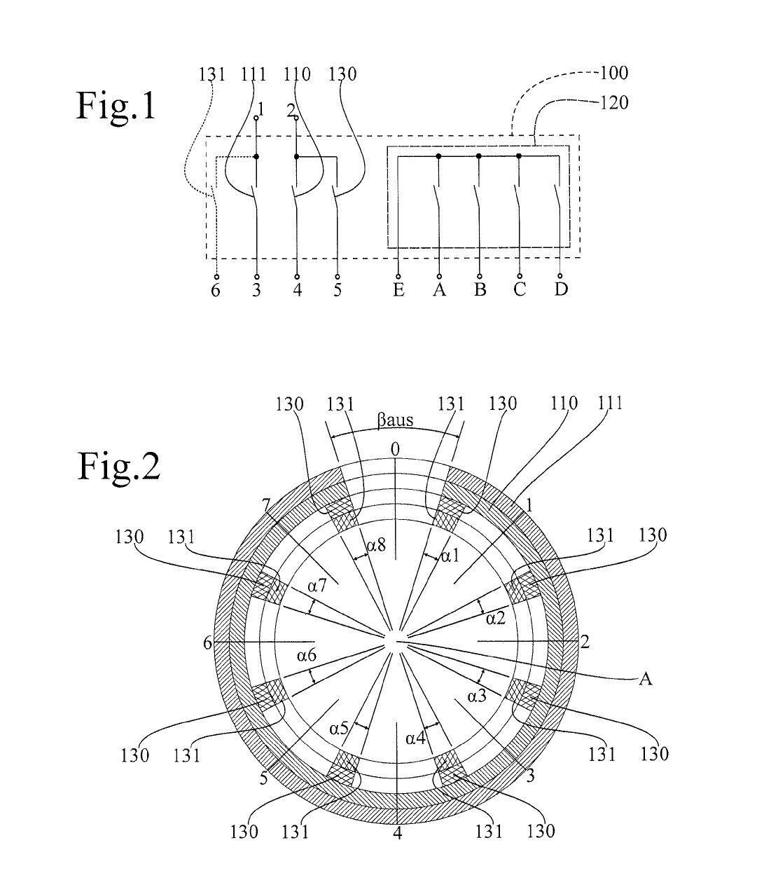

FIG. 1 shows an electrical equivalent circuit diagram of a first embodiment of a rotary selector 100 according to the disclosure herein. The rotary selector 100 is conventionally operated by a user where the latter turns an operating part (not illustrated) of the rotary selector about an axis A (see FIG. 2) until the rotary selector 100 or said operating part thereof respectively, reaches the designated angular position which, for example, corresponds to a program the user wanted to select by means of the rotary selector.

According to various embodiments, the rotary selector 100 includes a first switch contact 110, a second switch contact 130, a third switch contact 111, an optional fourth switch contact 131 as well as a conventional encoding device 120 generating an angle-dependent code over a predefined angular range.

The encoding device 120 connects the terminals A through D in an angle-dependent manner to terminal E. If, for example, a voltage is impressed on terminal E, said voltage applies to the terminals A through D if a related switch is closed. In this way, 16 different angular positions can theoretically be encoded. In the embodiment shown, see FIG. 2, 0 to 7 individual codes of the encoding device 120 are assigned to predefined angular positions.

For example, the encoding device 120 can be realized by means of electrically-conducting circular arcs on a printed circuit board (PCB) and corresponding electrically-conducting sliders sliding over said circular arcs if the rotary selector is actuated or turned into predefined angular positions whereby the switches of the encoding device 120 are correspondingly closed in the predefined angular positions.

FIG. 2 shows a switch state diagram of the switch contacts 110, 111, 130 and 131 of the rotary selector shown in FIG. 1. According to FIG. 2, the first switch contact 110 and the third switch contact 111 are in each case open in the off-mode angular range βaus and otherwise closed. The second switch contact 130 and the fourth switch contact 131 are in each case closed in the start-angular ranges α1 through α8 and otherwise open.

For example, the off-mode angular range βaus comprises angles between −20° and 20°. The start-angular ranges α1 through α8 have in each case a width of ca. 10°, for example, and are successively distributed over the entire 360° in an equidistant manner.

The number of said start-angular ranges α1 through α8 is identical to the number of different codes that can be encoded by means of the encoding device 120. In said case, the encoding device 120 generates eight different codes, that is to say a total of eight start-angular ranges α1 through α8 are provided which are centrally arranged between the predefined angular positions 0 through 7. It shall be understood that it is also possible to provide more or less than eight angular positions or start-angular ranges, respectively.

The off-mode angular range βaus can be selected depending on the number of predefined angular positions or the number of different codes, respectively, which can be encoded by the encoding device 120. With increasing number of predefined angular positions, the off-mode angular range βaus or the width thereof, respectively, becomes smaller. The width of the start-angular ranges α1 through α8 which also depends on the number of predefined angular positions is significantly smaller than the width of the off-mode angular range βaus, so that when operating the rotary selector 100, the wiping switch contacts 130 and 131 are only briefly switched on, supplying the electrical load with energy until the latter reaches a (self-)locking state.

For example, the switch contacts 110, 111, 130 and 131 include in each case a related switch spring (not shown) being actuated or traveled by means of suitable switching cams on a controller/switching cylinder, whereby in the case of a rotation of the controller cylinder, an opening or closing of the corresponding switch contact is effected by operating the rotary selector 100 as shown in FIG. 2.

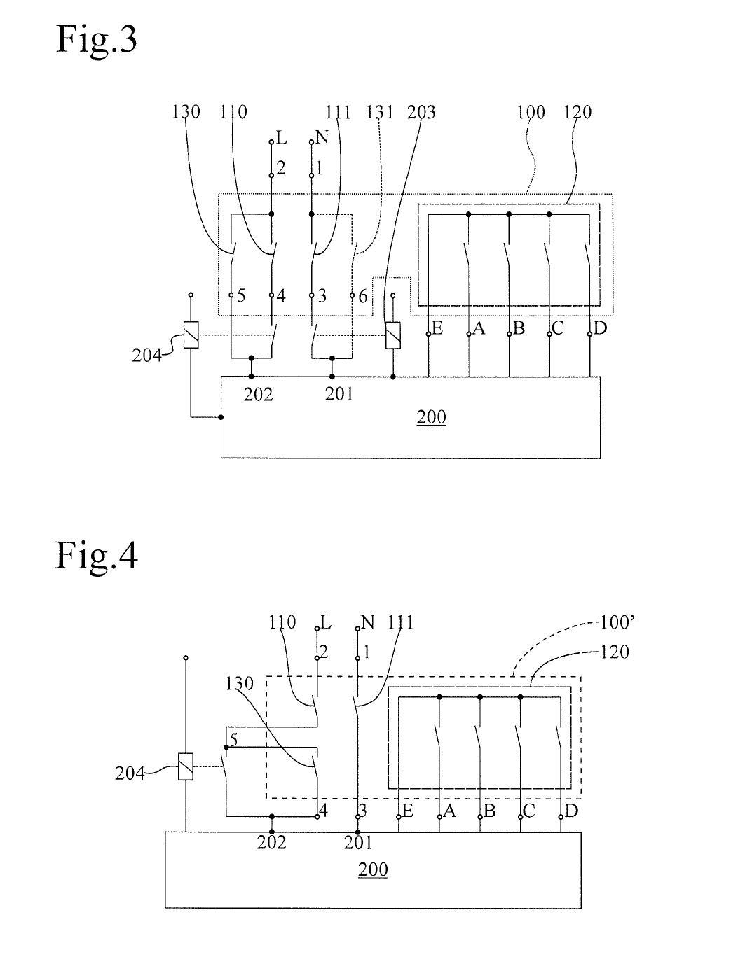

FIG. 3 shows a circuit diagram of a circuit according to the invention having the rotary selector 100 shown in FIG. 1. The circuit further includes an electrical load 200 having a first and a second supply voltage terminal 201 and 202 as well as two switch means controlled by the electrical load 200 in the form of relays 203 and 204. Conventionally, said relays include a relay coil as well as a make contact. Relay 203 is optional. For example, the electrical load 200 can be a device control having a micro processor for a home appliance such as a laundry drier, a dishwashing machine or a washing machine. In this case, the rotary selector 100 is used for means of performance adjustment and/or for selection of different operation programs via the rotary angle selected by a user.

A first terminal 2 of the switch contact 110 is connected to the first pole L of a mains voltage, the make contact of the relay 204 is connected between the second terminal 4 of the first switch contact 110 and the first supply voltage terminal 202 of the electrical load 200, a first terminal 1 of the third switch contact 111 is connected to the second pole N of the mains voltage, the make contact of the relay 203 is connected between the second terminal 3 of the third switch contact 111 and the second supply voltage terminal 201 of the electrical load 200, the second switch contact 130 is connected between the first pole L of the mains voltage and the first supply voltage terminal 202 of the electrical load 200, i.e. a first terminal 2 of the second switch contact 130 is connected to the first pole L of the mains voltage and a second terminal 5 of the second switch contact 130 is connected to the first supply voltage terminal 202 of the electrical load 200, and the fourth switch contact 131 is connected between the second pole N of the mains voltage and the second supply voltage terminal 201 of the electrical load 200, i.e. a first terminal 1 of the fourth switch contact 131 is connected to the second pole N of the mains voltage and a second terminal 6 of the fourth switch contact 131 is connected to the second supply voltage terminal 201 of the electrical load 200.

The role of the circuit shown in FIG. 3 is subsequently described in detail. Initially, it is assumed that the rotary selector or the operating part thereof takes an angular position within the off-mode angular range βaus. Thus, the respective switch contacts 110, 111, 130, 131 are open. Therefore the electrical load 200 is disconnected from the mains voltage in a two-phase manner, whereby electrical power dissipation is not incurred by the electrical load 200.

If now the operating part takes an angular position outside of the off-mode angular range βaus and within the start angular ranges α1 through α8 for the first time, the respective switch contacts 110, 111, 130 and 131 are closing, whereby initially the make contacts of the relays 203 and 204 remain open. Then, a supply of the electrical load 200 is effected via the respectively closed switch contacts 130 and 131.

Now, the electrical load 200 controls the coils of the relays 203 and 204 in such a way that the respective make contacts thereof are closing. As a result, the electrical load 200 is still supplied even when the switch contacts 130 and 131 are open due to an abandoning of the start-angular ranges α1 through α8. Hence, a (self-)locking state is reached.

After a user has selected a program by selection of one of the predefined angular positions 1 through 7 and, if applicable, a start button (not shown) is actuated, said program is started and executed. As soon as the program has been completely finished, the electrical load 200 controls the relays 203 and 204 in such a way that the respective make contacts are opened in order to effectuate an off-mode. Since the predefined angular positions 1 through 7 are selected in such a way that they do not overlap the start-angular ranges α1 through α8, that is to say the switch contacts 130 and 131 are open, said electrical load is completely disconnected from the mains voltage with the result that there is no power consumption on the part of the electrical load 200 in the off-mode. The electrical load 200 can then be switched on again by simply turning the rotary selector over one of the start-angular ranges α1 through α8.

FIG. 4 shows a circuit diagram of a circuit according to the invention having another embodiment of a rotary selector 100′ according to the invention. In this embodiment, the relay 203 shown in FIG. 3 as well as the switch contact 131 and the switch contacts 110 and 130 are connected in series and connected between the L pole of the mains voltage and the first supply voltage terminal 202. In said embodiment, merely a single-pole disconnection from the mains voltage is effected in the off-mode outside of the off-mode angular range βaus.

A common characteristic of the embodiments shown is that in addition to the switch contacts 110 and 111 that are closing outside of the off-mode angular range βaus, one or two wiping switch contacts 130 and 131 are provided, by means of which, when switching on, one or two relays 203 and 204 can be brought into a (self-)locking state. After a program completion, the electrical load 200 switches itself off by opening the relay(s) 203 and/or 204. By means of a short rotation of the rotary selector, the wiping contact(s) 130 and/or 131 is/are closed in the start-angular ranges α1 through α8 whereby an abandoning of the off-mode or standby-mode, respectively, is effected.

1. A rotary selector, comprising:
a first switch contact comprising an open configuration in an off-mode angular range and a closed configuration outside of the off-mode angular range;
an encoding device generating an angle-dependent code over a predefined angular range; and
a second switch contact comprising a closed configuration in a plurality of start-angular ranges and an open configuration outside of the start-angular ranges.

2. The rotary selector of claim 1, further comprising:
a third switch contact comprising an open configuration in the off-mode angular range and a closed configuration outside of the off-mode angular range; and
a fourth switch contact comprising a closed configuration in the plurality of start-angular ranges and an open configuration outside of the start-angular ranges.

3. The rotary selector of claim 1, wherein the off-mode angular range comprises angles between −40° and 40°.

4. The rotary selector of claim 3, wherein the off-mode angular range comprises angles between −20° and 20°.

5. The rotary selector of claim 1, wherein the plurality of start-angular ranges corresponds to a number of different codes which can be encoded by means of the encoding device.

6. The rotary selector of claim 1, wherein the start-angular ranges are successively distributed in an equidistant manner.

7. The rotary selector of claim 1, wherein each of the start-angular ranges comprises a width of 10°.

8. A circuit, comprising:
a rotary selector comprising:
a first switch contact comprising an open configuration in an off-mode angular range and a closed configuration outside of the off-mode angular range,
an encoding device generating an angle-dependent code over a predefined angular range, and
a second switch contact comprising a closed configuration in a plurality of start-angular ranges and an open configuration outside of the start-angular ranges;
an electrical load, comprising:
a first and a second supply voltage terminal, and
at least one switch means controlled by the electrical load, wherein
a first terminal of the first switch contact is connected to a first pole of a supply voltage,
the switch means is connected between a second terminal of the first switch contact and the first supply voltage terminal, and
the second switch contact is connected between the first pole of the supply voltage and the first supply voltage terminal

9. The circuit of claim 8, further comprising two switch means controlled by the electrical load, wherein
the first switch means is connected between the second terminal of the first switch contact and the first supply voltage terminal,
a first terminal of the third switch contact is connected to a second pole of the supply voltage,
the second switch means is connected between the second terminal of the third switch contact and the second supply voltage terminal,
the second switch contact is connected between the first pole of the supply voltage and the first supply voltage terminal, and
the fourth switch contact is connected between the second pole of the supply voltage and the second supply voltage terminal.

10. The circuit of claim 8, wherein the switch means comprise relays.
